(19) United States
(12) Patent Application Publication
(10) Pub. No.: US 2025/0174858 A1
(43) Pub. Date: May 29, 2025

(54) LIQUID INJECTION JIG AND LIQUID INJECTION SYSTEM

(71) Applicant: KABUSHIKI KAISHA TOSHIBA, Tokyo (JP)

(72) Inventor: Ryuichi ARAI, Kashiwazaki (JP)

(73) Assignee: KABUSHIKI KAISHA TOSHIBA, Tokyo (JP)

(21) Appl. No.: 19/037,432

(22) Filed: Jan. 27, 2025

Related U.S. Application Data
(63) Continuation of application No. PCT/JP2022/029284, filed on Jul. 29, 2022.

(51) Int. Cl. H01M 50/618; H01M 50/673

(52) U.S. Cl. CPC H01M 50/618; H01M 50/673

(57) ABSTRACT

In an embodiment, a liquid injection jig includes a peripheral wall, a bottom wall, and a plate-shaped portion. The peripheral wall surrounds a storage cavity where an electrolyte solution can be stored from an outer peripheral side. The bottom wall is connected to the peripheral wall with being adjacent to the storage cavity from one side in a height direction, and a discharge port through which an electrolyte solution can be discharged from the storage cavity toward a battery is formed in the bottom wall. The plate-shaped portion is connected to the peripheral wall in the storage cavity. A contact portion in contact with the peripheral wall and a separation portion having a gap with the peripheral wall are formed at the edge of the plate-shaped portion, and the gap is positioned away from the contact portion in a circumferential direction of the storage cavity.

### CROSS-REFERENCE TO RELATED APPLICATION

This is a Continuation Application of PCT Application No. PCT/JP2022/029284, filed Jul. 29, 2022, the entire contents of which are incorporated herein by reference.

### FIELD

Embodiments relate to a liquid injection jig and a liquid injection system.

### BACKGROUND

In the manufacture of a battery, an electrolyte solution is injected into the battery in which an electrode group or the like is disposed from a liquid injection port formed in an exterior portion of the battery. At this time, an electrolyte solution is discharged from a discharge port of a liquid injection hopper, which is a liquid injection jig, toward the inside of the battery through the liquid injection port, and the electrolyte solution is injected into the battery. In addition, in the injection of the electrolyte solution into the battery using the liquid injection hopper, the inside of the chamber in which the battery is disposed is depressurized, and gas is discharged from the inside of the battery. At this time, at least a part of the gas discharged from the inside of the battery forms bubbles in the electrolyte solution to be injected, and is discharged from the inside of the battery to the inside of the liquid injection hopper. Then, in the liquid injection hopper, small droplets of the electrolyte solution occur by the bursting of bubbles that are gas discharged from the inside of the battery.

In the injection of an electrolyte solution into the battery, even when small droplets of the electrolyte solution occur in the liquid injection hopper due to the bursting of bubbles discharged from the inside of the battery, it is required to appropriately prevent leakage of the small droplets that have occurred to the outside of the liquid injection hopper which is a liquid injection jig. Then, it is required to appropriately prevent adhesion of the small droplets of the electrolyte solution to the outer surface of the battery by preventing leakage of the small droplets to the outside of the liquid injection jig.

### BRIEF DESCRIPTION OF THE DRAWINGS

FIG. 1 is a schematic diagram showing a liquid injection system according to a first embodiment.

FIG. 2 is a cross-sectional view schematically showing the liquid injection hopper or the like according to the first embodiment in a cross-section orthogonal or substantially orthogonal to the depth direction of the liquid injection hopper.

FIG. 3 is a schematic view showing the liquid injection hopper according to the first embodiment as viewed from one side in the height direction of the liquid injection hopper.

FIG. 4 is a cross-sectional view schematically showing a state in which the storage cavity of the liquid injection hopper is replenished with the electrolyte solution by discharge from the nozzle in the liquid injection system according to the first embodiment in a cross-section orthogonal or substantially orthogonal to the depth direction of the liquid injection hopper.

FIG. 5 is a cross-sectional view schematically showing a state in which the electrolyte solution is stored in the storage cavity of the liquid injection hopper by the replenishment of the electrolyte solution in FIG. 4 in the liquid injection system according to the first embodiment in a cross-section orthogonal or substantially orthogonal to the depth direction of the liquid injection hopper.

FIG. 6 is a cross-sectional view schematically showing a state in which bubbles are generated in the electrolyte solution by the gas discharged from the inside of the battery into the storage cavity of the liquid injection hopper in the liquid injection system according to the first embodiment in a cross-section orthogonal or substantially orthogonal to the depth direction of the liquid injection hopper.

FIG. 7 is a cross-sectional view schematically showing a state in which the electrolyte solution is discharged from the discharge port of the liquid injection hopper into the battery in the liquid injection system according to the first embodiment in a cross-section orthogonal or substantially orthogonal to the depth direction of the liquid injection hopper.

FIG. 8 is a cross-sectional view schematically showing a liquid injection hopper and the like according to a first modification in a cross-section orthogonal or substantially orthogonal to the depth direction of the liquid injection hopper.

FIG. 9 is a cross-sectional view schematically showing a liquid injection hopper and the like according to a second modification in a cross-section orthogonal or substantially orthogonal to the depth direction of the liquid injection hopper.

FIG. 10 is a cross-sectional view schematically showing a liquid injection hopper and the like according to third modification in a cross-section orthogonal or a substantially orthogonal to the depth direction of the liquid injection hopper.

FIG. 11 is a cross-sectional view schematically showing a liquid injection hopper and the like according to a fourth modification in a cross-section orthogonal or substantially orthogonal to the width direction of the liquid injection hopper.

FIG. 12 is a schematic view showing the liquid injection hopper according to the fourth modification as viewed from one side in the height direction of the liquid injection hopper.

### DETAILED DESCRIPTION

According to an embodiment, a liquid injection jig includes a peripheral wall, a bottom wall, and a plate-shaped portion. The peripheral wall surrounds a storage cavity in which the electrolyte solution can be stored from the outer peripheral side. The bottom wall is connected to one end of the peripheral wall in a state where the bottom wall is adjacent to the storage cavity from one side in the height direction, and a discharge port through which an electrolyte solution to be injected into the battery can be discharged from the storage cavity toward the inside of the battery is formed in the bottom wall. The plate-shaped portion is connected to the peripheral wall in the storage cavity. A contact portion in contact with the peripheral wall and a separation portion having a gap with the peripheral wall are formed at the edge of the plate-shaped portion, and the gap between the separation portion of the plate-shaped portion and the peripheral wall is positioned away from the contact portion of the plate-shaped portion in the circumferential direction of the storage cavity.

Hereinafter, embodiments will be described with reference to the drawings.

### First Embodiment

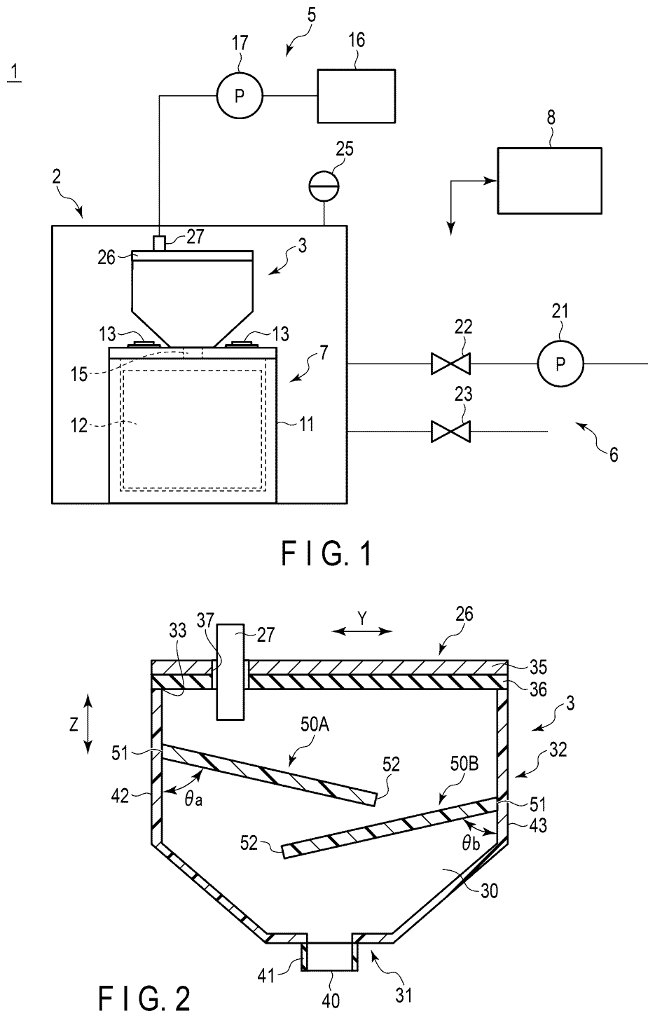

First, a first embodiment will be described as an example of the embodiments. FIG. 1 shows a liquid injection system 1 according to the first embodiment. As shown in FIG. 1, the liquid injection system 1 includes a chamber 2, a liquid injection hopper 3 that is a liquid injection jig, a supply unit 5, a pressure adjustment unit 6, a battery 7, and a controller 8. In the liquid injection system 1, the battery 7 is disposed inside the chamber 2, and the liquid injection system 1 is used for injection of an electrolyte solution into the battery 7 at the time of manufacturing the battery 7.

The battery 7 includes an exterior portion 11 such as an exterior container, and an electrolyte solution is injected into the exterior portion 11. An electrode group 12 is stored inside the exterior portion 11. Injection of the electrolyte solution into the exterior portion 11 impregnates the electrode group 12 with the electrolyte solution. The electrode group 12 includes a positive electrode and a negative electrode (neither shown), and in the electrode group 12, the positive electrode and the negative electrode are electrically insulated from each other by, for example, a separator (not shown). In the battery 7 of an example in FIG. 1, a pair of electrode terminals 13 is attached to the exterior portion 11, and the pair of electrode terminals 13 is exposed on the outer surface of the exterior portion 11. A current collector of the positive electrode of the electrode group 12 is electrically connected to the positive electrode terminal that is one of the pair of electrode terminals 13 through one or more leads (not shown). Then, a current collector of the negative electrode of the electrode group 12 is electrically connected to the negative electrode terminal that is the other of the pair of electrode terminals 13 through one or more leads (not shown).

In addition, a liquid injection port 15 is formed on the outer surface of the exterior portion 11. The electrolyte solution is injected into the battery 7 through the liquid injection port 15. It should be noted that the configuration of the battery 7 is not particularly limited as long as the electrode group 12 is stored inside the exterior portion 11, and the liquid injection port 15 that allows the injection of an electrolyte solution into the exterior portion 11 is formed in the exterior portion 11. In addition, the electrolyte solution is a solution in which an electrolyte is dissolved in a solvent, and the solvent for dissolving the electrolyte may be a nonaqueous solvent such as an organic solvent or an aqueous solvent.

In addition, in the injection of the electrolyte solution into the battery 7, the electrolyte solution is discharged from the liquid injection hopper 3 that is a liquid injection jig toward the inside of the battery 7 through the liquid injection port 15, and the electrolyte solution is injected into the battery 7. The supply unit 5 supplies an electrolyte solution to the liquid injection hopper 3. In an example in FIG. 1, the supply unit 5 includes a tank 16 and a pump 17. In the supply unit 5, the electrolyte solution is stored in the tank 16. Then, in the supply unit 5, by operating the pump 17, the pump 17 discharges the electrolyte solution from the tank 16 toward the liquid injection hopper 3, and the electrolyte solution is supplied to the liquid injection hopper 3.

The pressure adjustment unit 6 can adjust the pressure inside the chamber 2, and for example, reduce the pressure inside the chamber 2. The pressure adjustment unit 6 includes a pump 21 and valves 22 and 23. Each of the valves 22 and 23 is switchable between an open state and a closed state. By the operation of the pump 21 when the valve 22 is in the open state, gas is discharged from the inside of the chamber 2 by suction by the pump 21. Accordingly, the inside of the chamber 2 is depressurized. In addition, by setting the valve 23 to the open state, the inside of the chamber 2 is opened to the atmosphere. By the opening to the atmosphere, the pressure inside the chamber 2 becomes atmospheric pressure. In addition, in the liquid injection system 1 of an example in FIG. 1, a pressure gauge 25 for measuring the pressure inside the chamber 2 is provided.

The controller 8 is composed of, for example, a computer and includes a processor or an integrated circuit (control circuit) and a storage medium (non-transitory storage medium) such as a memory. The processor or the integrated circuit includes a central processing unit (CPU), an application specific integrated circuit (ASIC), a field programmable gate array (FPGA), or the like. The controller 8 may include one integrated circuit or the like, or may include a plurality of integrated circuits or the like. The controller 8 performs processing by executing a program or the like stored in a storage medium or the like. The controller 8 controls the supply of the electrolyte solution from the supply unit 5 to the liquid injection hopper 3 by, for example, controlling the operation of the pump 17 of the supply unit 5.

In addition, the controller 8 controls the pressure inside the chamber 2 by, for example, controlling the operations of the pump 21 and the valves 22 and 23 of the pressure adjustment unit 6. The controller 8 controls the pressure inside the chamber 2 based on the measurement result at the pressure gauge 25. In addition, a lid member 26 is attached to the liquid injection hopper 3. Then, a nozzle 27 is attached to the lid member 26. An electrolyte solution is supplied from the supply unit 5 to the nozzle 27, and the nozzle 27 discharges the supplied electrolyte solution toward the inside of the liquid injection hopper 3.

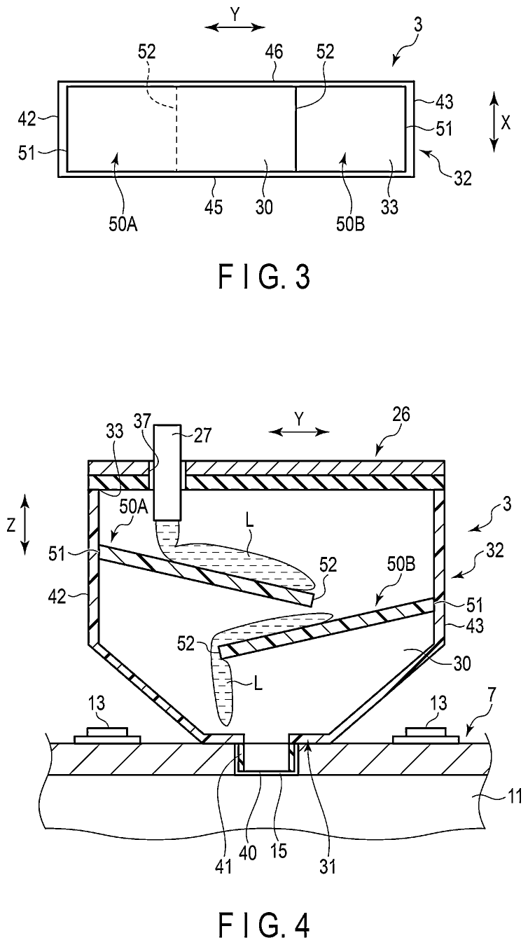

FIGS. 2 and 3 show the configuration of the liquid injection hopper 3 that is a liquid injection jig. In FIG. 2, the lid member 26 and the nozzle 27 are shown in addition to the liquid injection hopper 3. As shown in FIGS. 2 and 3 and the like, a storage cavity 30 capable of storing the electrolyte solution is formed inside the liquid injection hopper 3. In the liquid injection hopper 3 and the storage cavity 30, a height direction (a direction indicated by an arrow Z), a width direction (a direction indicated by an arrow Y) intersecting (orthogonal or substantially orthogonal to) the height direction, and a depth direction (a direction indicated by an arrow X) intersecting (orthogonal or substantially orthogonal to) both the height direction and the width direction are defined. FIG. 2 shows the liquid injection hopper 3 and the like in a cross-section orthogonal or substantially orthogonal to the depth direction, and FIG. 3 shows the liquid injection hopper 3 as viewed from one side in the height direction. In addition, in an example in FIGS. 2 and 3, the dimension of the liquid injection hopper 3 along the width direction is larger than the dimension of the liquid injection hopper 3 along the depth direction. Then, the dimension of the storage cavity 30 along the width direction is larger than the dimension of the storage cavity 30 along the depth direction.

The liquid injection hopper 3 is formed of, for example, a resin or the like having resistance to an electrolyte solution, and includes a bottom wall 31 and a peripheral wall 32. The bottom wall 31 is adjacent to the storage cavity 30 from one side in the height direction, and the peripheral wall 32 surrounds the storage cavity 30 from the outer peripheral side. The peripheral wall 32 surrounds the storage cavity 30 over the entire circumference in the circumferential direction of the storage cavity 30 (liquid injection hopper 3). The bottom wall 31 is connected to one end of the peripheral wall 32. The peripheral wall 32 extends along the height direction from a connection portion with the bottom wall 31. It should be noted that in FIG. 3, the liquid injection hopper 3 is shown as viewed from the side opposite to the bottom wall 31 in the height direction.

In the liquid injection hopper 3, the storage cavity 30 has an opening 33, and the storage cavity 30 opens at the opening 33 to the side opposite to the side where the bottom wall 31 is positioned in the height direction. The opening edge of the opening 33 is formed, in the peripheral wall 32, by an end portion opposite to the bottom wall 31. The lid member 26 is attached to the peripheral wall 32 of the liquid injection hopper 3 from the side opposite to the side where the bottom wall 31 is positioned in the height direction. In addition, the lid member 26 is formed in a plate shape, and is attached to the peripheral wall 32 in a state where the plate thickness direction coincides with or substantially coincides with the height direction of the liquid injection hopper 3. By the lid member 26 being attached to the peripheral wall 32, the opening 33 of the storage cavity 30 is covered with the lid member 26.

In an example in FIG. 2, the lid member 26 includes a metal plate portion 35 and a rubber plate portion 36. Then, by the lid member 26 being attached to the peripheral wall 32, the metal plate portion 35 is stacked on the side opposite to the storage cavity 30 with respect to the rubber plate portion 36. In a certain example, the metal plate portion 35 is formed of stainless steel, and the rubber plate portion 36 is formed of ethylene propylene rubber.

One or more holes 37 penetrating the lid member 26 in the plate thickness direction are formed in the lid member 26. The nozzle 27 is attached to the lid member 26 in a state of being inserted through any one of the holes 37. Therefore, in a state where the nozzle 27 is attached to the lid member 26, the nozzle 27 is inserted into the storage cavity 30 of the liquid injection hopper 3 through any one of the holes 37. The nozzle 27 discharges the electrolyte solution supplied from the supply unit 5 toward the storage cavity 30 of the liquid injection hopper 3.

In the liquid injection hopper 3, a discharge port 40 is formed in the bottom wall 31. In the discharge port 40, the storage cavity 30 opens to the side opposite to the side where the opening 33 opens in the height direction. The electrolyte solution stored in the storage cavity 30 can be discharged from the discharge port 40 to the outside of the liquid injection hopper 3. In the injection of the electrolyte solution into the battery 7, the electrolyte solution is discharged from the discharge port 40 of the liquid injection hopper 3 toward the inside of the battery 7 through the liquid injection port 15. In an example in FIG. 2 and the like, a protrusion 41 protruding to the side opposite to the side where the opening 33 opens in the height direction is formed on the bottom wall 31. The discharge port 40 is formed at the protruding end of the protrusion 41. It should be noted that in an example in FIG. 2 and the like, the protrusion 41 is formed of rubber or the like.

In addition, in an example in FIGS. 2 and 3 and the like, the peripheral wall 32 of the liquid injection hopper 3 includes side walls 42, 43, 45, and 46. The side wall 42 is adjacent to the storage cavity 30 from one side in the width direction, and the side wall 43 is adjacent to the storage cavity 30 from the side opposite to the side wall 42 in the width direction. Therefore, the side wall 43 faces the side wall 42 with the storage cavity 30 interposed in the width direction. In addition, the side wall 45 is adjacent to the storage cavity 30 from one side in the depth direction, and the side wall 46 is adjacent to the storage cavity 30 from the side opposite to the side wall 45 in the depth direction. Therefore, the side wall 46 faces the side wall 45 with the storage cavity 30 interposed in the depth direction. Each of the side walls 42 and 43 extends between the side walls 45 and 46 along the depth direction and connects the side walls 45 and 46. In addition, each of the side walls 45 and 46 extends between the side walls 42 and 43 along the width direction and connects the side walls 42 and 43.

In the liquid injection hopper 3, the plate-shaped portions 50A and 50B are disposed in the storage cavity 30, and in an example in FIGS. 2 and 3, two plate-shaped portions 50A and 50B are provided. In the liquid injection hopper 3, each of the plate-shaped portions 50A and 50B is disposed between the bottom wall 31 and the opening 33 in the height direction, that is, between the discharge port 40 and the opening 33 in the height direction. Each of the plate-shaped portions 50A and 50B is connected to the peripheral wall 32 in the storage cavity 30. In an example, the plate-shaped portions 50A and 50B are formed integrally with the bottom wall 31 and the peripheral wall 32. In another example, each of the plate-shaped portions 50A and 50B is formed separately from the bottom wall 31 and the peripheral wall 32. Then, each of the plate-shaped portions 50A and 50B is attached to the peripheral wall 32, thereby being connected to the peripheral wall 32. In this case, each of the plate-shaped portions 50A and 50B is attached to the peripheral wall 32 by any one of screwing, fitting between the protruding portion and the recessed portion, and the like.

In addition, a contact portion 51 in contact with the peripheral wall 32 and a separation portion 52 having a gap with the peripheral wall 32 are formed at the edge of each of the plate-shaped portions 50A and 50B. In each of the plate-shaped portions 50A and 50B, the edge is not in contact with the peripheral wall 32 at the separation portion 52. In an example in FIGS. 2 and 3 and the like, in the plate-shaped portion (first plate-shaped portion) 50A, the contact portion 51 is in contact with the side wall (first side wall) 42, and the separation portion 52 forms a gap with the side wall (second side wall) 43. Then, in the plate-shaped portion (second plate-shaped portion) 50B, the contact portion 51 is in contact with the side wall (second side wall) 43, and the separation portion 52 forms a gap with the side wall (first side wall) 42. In addition, in each of the plate-shaped portions 50A and 50B, the contact portion 51 is in contact with each of the side wall (third side wall) 45 and the side wall (fourth side wall) 46.

Due to the above-described configuration, in an example in FIGS. 2 and 3, the peripheral wall 32 comes into contact with the edge of the plate-shaped portion 50A from both sides in the depth direction and one side in the width direction. Then, the peripheral wall 32 comes into contact with the plate-shaped portion 50B from both sides in the depth direction and from the side opposite to the side in contact with the plate-shaped portion 50A in the width direction. In addition, a gap between the separation portion 52 of the plate-shaped portion 50A and the side wall 43 of the peripheral wall 32 is positioned away from the contact portion 51 of the plate-shaped portion 50A in the circumferential direction of the storage cavity 30. Then, a gap between the separation portion 52 of the plate-shaped portion 50B and the side wall 42 of the peripheral wall 32 is positioned away from the contact portion 51 of the plate-shaped portion 50B in the circumferential direction of the storage cavity 30.

In addition, in the storage cavity 30, the plate-shaped portions 50A and 50B are not in contact with each other. Therefore, in the storage cavity 30, the plate-shaped portion (second plate-shaped portion) 50B forms a gap with the plate-shaped portion (first plate-shaped portion) 50A. The plate-shaped portions 50A and 50B are disposed away from each other in the height direction. In an example in FIGS. 2 and 3 and the like, the plate-shaped portion 50B is disposed on the side where the bottom wall 31 (discharge port 40) is positioned in the height direction with respect to the plate-shaped portion 50A.

In addition, in an example in FIG. 3 and the like, the range surrounded by the peripheral wall 32 in a projection view from the height direction includes a portion in which only the plate-shaped portion 50A extends, a portion in which only the plate-shaped portion 50B extends, and a portion in which the plate-shaped portions 50A and 50B overlap. Therefore, in a projection view from the height direction, in the range surrounded by the peripheral wall 32, there is no portion where neither of the plate-shaped portions 50A and 50B extends. It should be noted that in a portion where the plate-shaped portions 50A and 50B overlap in a projection view from the height direction, the plate-shaped portions 50A and 50B are separated from each other in the height direction.

In addition, in the present embodiment, as shown in FIG. 2 and the like, each of the plate-shaped portions 50A and 50B is inclined with respect to each of the height direction and the width direction. Each of the plate-shaped portions 50A and 50B is inclined to be in a state of being positioned on the side where the bottom wall 31 (discharge port 40) is positioned in the height direction as it comes closer to the separation portion 52. Therefore, the plate-shaped portion 50A is positioned on the side where the bottom wall 31 is positioned in the height direction as it comes closer to the separation portion 52 from the side wall 42 in the width direction. Then, the plate-shaped portion 50B is positioned on the side where the bottom wall 31 is positioned in the height direction as it comes closer to the separation portion 52 from the side wall 43 in the width direction.

In addition, an angle θa formed by the extending direction of the plate-shaped portion 50A toward the separation portion 52 with respect to the side where the bottom wall 31 is positioned in the height direction and an angle θb formed by the extending direction of the plate-shaped portion 50B toward the separation portion 52 with respect to the side where the bottom wall 31 is positioned in the height direction are defined. In the present embodiment, each of the plate-shaped portions 50A and 50B is inclined as described above with respect to each of the height direction and the width direction. Therefore, each of the angles θa and θb is an acute angle.

When the electrolyte solution is injected into the battery 7 using the liquid injection hopper 3 and the liquid injection system 1 as described above, as shown in FIG. 4, the protrusion 41 of the bottom wall 31 of the liquid injection hopper 3 is inserted into the liquid injection port 15 of the battery 7. Then, in a state where the protrusion 41 is inserted into the liquid injection port 15, the electrolyte solution L is supplied from the supply unit 5 to the nozzle 27, and the electrolyte solution L is discharged from the nozzle 27 to the storage cavity 30. In the storage cavity 30, the electrolyte solution L discharged from the nozzle 27 sequentially passes through a surface of the plate-shaped portion 50A facing the side where the opening 33 is positioned, a gap between the separation portion 52 of the plate-shaped portion 50A and the side wall 43, a surface of the plate-shaped portion 50B facing the side where the opening 33 is positioned, and a gap between the separation portion 52 of the plate-shaped portion 50B and the side wall 42, and flows toward the side where the bottom wall 31 is positioned. In addition, when the electrolyte solution L flows on the surface of the plate-shaped portion 50B facing the side where the opening 33 is positioned, the electrolyte solution L passes through the gap between the plate-shaped portions 50A and 50B.

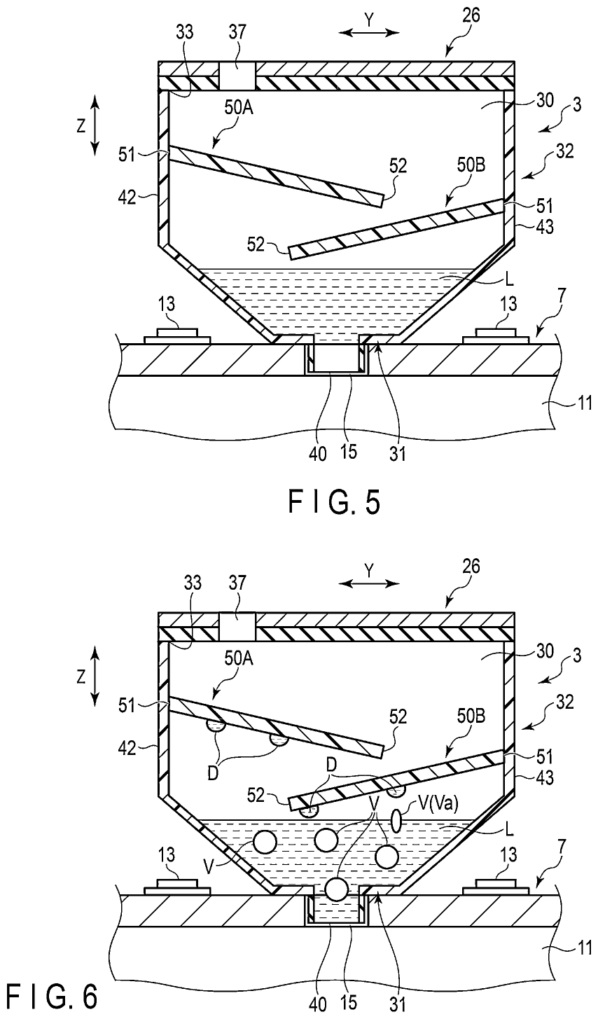

The electrolyte solution L replenished to the storage cavity 30 by the discharge from the nozzle 27 in the above-described manner is stored in the storage cavity 30 of the liquid injection hopper 3 as shown in FIG. 5. Here, FIG. 4 shows a state in which the storage cavity 30 of the liquid injection hopper 3 is being replenished with the electrolyte solution L by the discharge from the nozzle 27, and FIG. 5 shows a state in which the electrolyte solution L is stored in the storage cavity 30 of the liquid injection hopper 3 by the replenishment of the electrolyte solution L in FIG. 4. In the injection of the electrolyte solution L into the battery 7, the inside of the chamber 2 in which the battery 7 is disposed is depressurized in a state where the electrolyte solution L is stored in the storage cavity 30 of the liquid injection hopper 3. At this time, the inside of the chamber 2 is depressurized by, for example, setting the valve 22 to an open state and operating the pump 21.

By the depressurization of the inside of chamber 2, gas is discharged from the inside of the battery 7. At this time, as shown in FIG. 6 and the like, at least a part of the gas discharged from the inside of the battery 7 becomes bubbles V in the liquid of the electrolyte solution L to be injected, and is discharged from the inside of the battery 7 to the storage cavity 30 of the liquid injection hopper 3. FIG. 6 shows a state in which bubbles V are generated in the liquid of the electrolyte solution L by the gas discharged from the inside of the battery 7 into the storage cavity 30 of the liquid injection hopper 3. In the storage cavity 30 of the liquid injection hopper 3, bubbles, which are gas discharged from the inside of the battery 7, burst to cause small droplets D of the electrolyte solution L to occur. In the state in FIG. 6, a bubble Va that is one of the bubbles V bursts, and small droplets D occur.

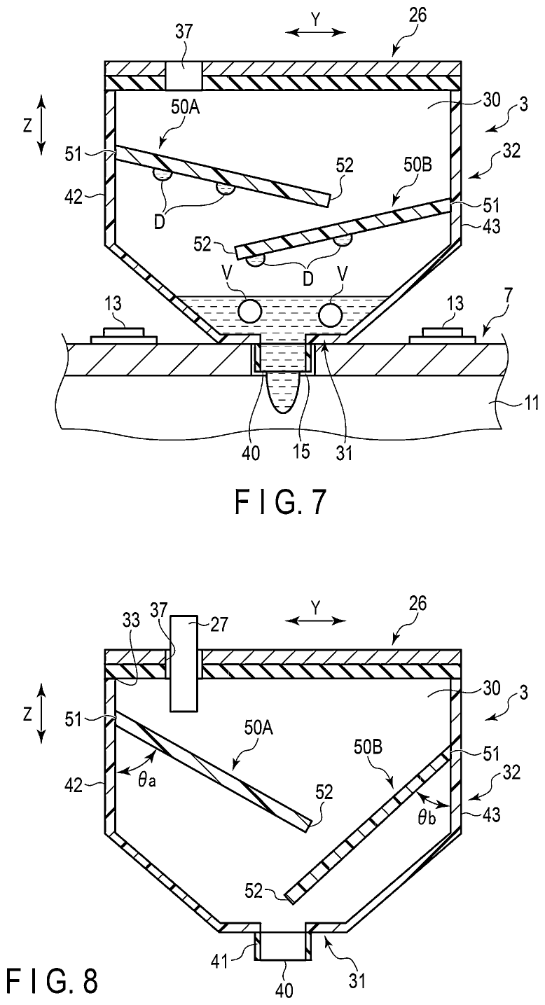

Then, by the gas being discharged from the inside of the battery 7 in the above-described manner, as shown in FIG. 7 and the like, the electrolyte solution L is discharged from the discharge port 40 of the liquid injection hopper 3 to the inside of the battery 7, and the electrolyte solution L is injected to the inside of the battery 7 in which the electrode group 12 is stored. FIG. 7 shows a state in which the electrolyte solution L is discharged from the discharge port 40 of the liquid injection hopper 3 into the battery 7. In the discharge of the electrolyte solution L in FIG. 7 and the like, the electrolyte solution L is discharged from the discharge port 40 of the liquid injection hopper 3 to the inside of the battery 7 in a state where the small droplets D occur by the bursting of the bubbles V.

As described above, in the present embodiment, each of the plate-shaped portions 50A and 50B is connected to the peripheral wall 32 in the storage cavity 30 of the liquid injection hopper 3. Therefore, even when the small droplets D of the electrolyte solution occur in the storage cavity 30 of the liquid injection hopper 3 as described above due to the bursting of the bubbles V discharged from the inside of the battery 7, as shown in FIGS. 6 and 7 and the like, the small droplets D that have occurred are effectively prevented from moving to the side where the lid member 26 (opening 33) is positioned beyond the plate-shaped portions 50A and 50B. Accordingly, the small droplets D of the electrolyte solution are appropriately prevented from leaking to the outside of the liquid injection hopper 3 through the gap at the attachment portion between the lid member 26 and the peripheral wall 32 and the hole 37 of the lid member 26. Since leakage of the small droplets D to the outside of the liquid injection hopper 3 is prevented, adhesion and the like of the small droplets D of the electrolyte solution to the outer surface of the exterior portion 11 of the battery 7 are appropriately prevented in the injection of the electrolyte solution into the battery 7.

In addition, in the present embodiment, a contact portion 51 in contact with the peripheral wall 32 and a separation portion 52 having a gap with the peripheral wall 32 are formed at the edge of each of the plate-shaped portions 50A and 50B. Therefore, even when the plate-shaped portions 50A and 50B are provided, the electrolyte solution L discharged from the nozzle 27 flows through the gap between the separation portion 52 of each of the plate-shaped portions 50A and 50B and the peripheral wall 32 in the storage cavity 30. Therefore, even when the plate-shaped portions 50A and 50B are provided, the electrolyte solution L discharged from the nozzle 27 appropriately reaches the discharge port 40 in the storage cavity 30.

In addition, in the liquid injection hopper 3 in FIGS. 2 and 3 and the like, in a projection view from the height direction, in the range surrounded by the peripheral wall 32, there is no portion where neither of the plate-shaped portions 50A and 50B extends. Accordingly, the small droplets D are more effectively prevented from moving to the side where the lid member 26 (opening 33) is positioned beyond the plate-shaped portions 50A and 50B. Therefore, the leakage of the small droplets D of the electrolyte solution to the outside of the liquid injection hopper 3 is more appropriately prevented.

In addition, in the liquid injection hopper 3 of the present embodiment, each of the plate-shaped portions 50A and 50B is inclined with respect to the height direction in a state of being positioned on a side where the bottom wall 31 (discharge port 40) is positioned in the height direction as it comes closer to the separation portion 52. That is, each of the above-described angles θa and θb becomes an acute angle. Therefore, the electrolyte solution L discharged from the nozzle 27 is less likely to stay on the surface facing the side where the opening 33 (lid member 26) is positioned in each of the plate-shaped portions 50A and 50B. Since the electrolyte solution L is less likely to stay in each of the plate-shaped portions 50A and 50B, even when the bubbles V burst in the storage cavity 30 as described above, the small droplets D caused by the electrolyte solution that stays in the plate-shaped portions 50A and 50B do not occur or hardly occur. Accordingly, the leakage of the small droplets D of the electrolyte solution to the outside of the liquid injection hopper 3 is more appropriately prevented.

### (Modifications)

Also in the first modification shown in FIG. 8, plate-shaped portions 50A and 50B are provided in the storage cavity 30 of the liquid injection hopper 3. Then, similarly to the above-described embodiment and the like, an angle θa formed by the extending direction of the plate-shaped portion 50A toward the separation portion 52 with respect to the side where the bottom wall 31 is positioned in the height direction and an angle θb formed by the extending direction of the plate-shaped portion 50B toward the separation portion 52 with respect to the side where the bottom wall 31 is positioned in the height direction are defined. However, in the present modification, each of the acute angles θa and θb is smaller than that of the above-described embodiment and the like. It should be noted that FIG. 8 shows the liquid injection hopper 3 and the like in a cross-section orthogonal or substantially orthogonal to the depth direction, and FIG. 8 shows the lid member 26 and the nozzle 27 in addition to the liquid injection hopper 3.

Also in the present modification, actions and effects similar to those of the above-described embodiment and the like are achieved. In the present modification, since each of the angles θa and θb is reduced, the electrolyte solution L discharged from the nozzle 27 more easily flows toward the discharge port 40 in the storage cavity 30. In addition, since each of the angles θa and θb is reduced, even when a spray of the electrolyte solution due to the collision of the electrolyte solution discharged from the nozzle 27 with either the plate-shaped portion 50A or 50B, the spray is less likely to scatter to the side where the lid member 26 (opening 33) is positioned. Accordingly, leakage of the electrolyte solution to the outside of the liquid injection hopper 3 due to the spray of the electrolyte solution can be effectively prevented.

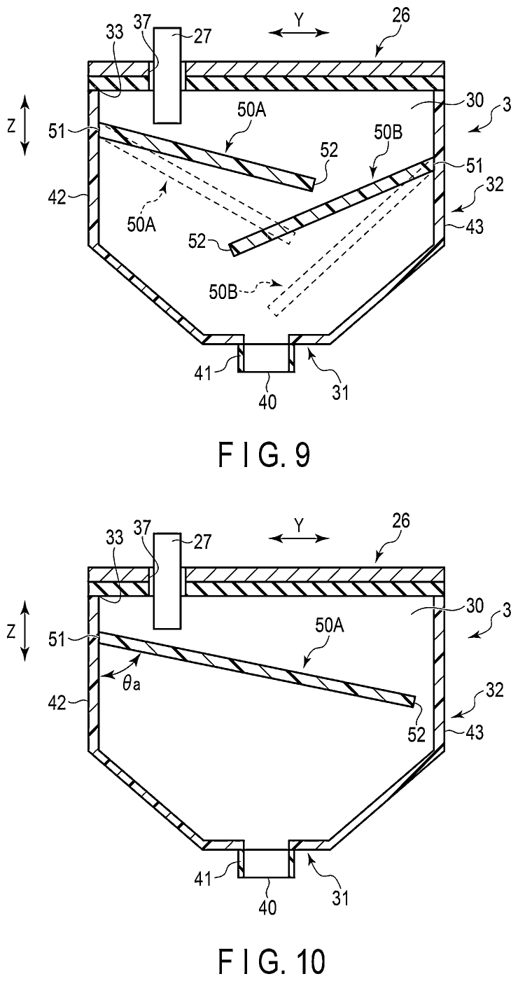

In addition, in a second modification shown in FIG. 9, the angle formed by each of the plate-shaped portions 50A and 50B with respect to the height direction of the liquid injection hopper 3 can be changed. That is, the inclination state of each of the plate-shaped portions 50A and 50B with respect to the height direction of the liquid injection hopper 3 can be changed. Therefore, each of the above-described angles θa and θb can be changed. It should be noted that FIG. 9 shows the liquid injection hopper 3 and the like in a cross-section orthogonal or substantially orthogonal to the depth direction, and FIG. 9 shows the lid member 26 and the nozzle 27 in addition to the liquid injection hopper 3.

In the present modification, the plate-shaped portion 50A is connected to the side wall 42 of the peripheral wall 32 by, for example, a hinge, and is pivotable around a connection position to the side wall 42. Then, the plate-shaped portion 50B is connected to the side wall 43 of the peripheral wall 32 by, for example, a hinge, and is pivotable around a connection position to the side wall 43. In this case, the pivoting axis of each of the plate-shaped portions 50A and 50B extends along the depth direction of the liquid injection hopper 3. In addition, in an example in FIG. 9, each of the plate-shaped portions 50A and 50B is pivotable between a position indicated by a solid line and a position indicated by a broken line. However, in an example in FIG. 9, the angle θa is an acute angle even in a state where the plate-shaped portion 50A is positioned at either the position indicated by the solid line or the position indicated by the broken line. Then, the angle θb is an acute angle even in a state where the plate-shaped portion 50B is positioned at either the position indicated by the solid line or the position indicated by the broken line.

Also in the present modification, actions and effects similar to those of the above-described embodiment and the like are achieved. In addition, in the present modification, in a state where the electrolyte solution is being discharged from the nozzle 27 to the storage cavity 30, each of the plate-shaped portions 50A and 50B is caused to pivot to a position indicated by a broken line, and each of the angles θa and θb is reduced. Accordingly, the electrolyte solution L discharged from the nozzle 27 easily flows toward the discharge port 40 in the storage cavity 30. In addition, as described above, even when a spray of the electrolyte solution occurs, the spray is less likely to scatter to the side where the lid member 26 (opening 33) is positioned.

In addition, in the present modification, when the storage cavity 30 is replenished with the electrolyte solution by the discharge of the electrolyte solution from the nozzle 27 and then the inside of the chamber 2 in which the battery 7 is disposed is depressurized, each of the plate-shaped portions 50A and 50B is caused to pivot to the position indicated by the solid line. Accordingly, even when the small droplets D occur by the bursting of the bubbles V as described above, the small droplets D are effectively prevented from moving to the side where the lid member 26 (opening 33) is positioned beyond the plate-shaped portions 50A and 50B.

In addition, in a third modification shown in FIG. 10, only the plate-shaped portion 50A is disposed in the storage cavity 30 of the liquid injection hopper 3, and the plate-shaped portion 50B is not disposed. Also in the present modification, the contact portion 51 is in contact with the side walls 42, 45, and 46 at the edge of the plate-shaped portion 50A, and the separation portion 52 has a gap with the side wall 43. However, in the present modification, since the plate-shaped portion 50B is not provided, a space between the separation portion 52 of the plate-shaped portion 50A and the peripheral wall 32 is preferably as small as possible within a range where the electrolyte solution can pass. It should be noted that FIG. 10 shows the liquid injection hopper 3 and the like in a cross-section orthogonal or substantially orthogonal to the depth direction, and FIG. 10 shows the lid member 26 and the nozzle 27 in addition to the liquid injection hopper 3.

In addition, in a certain modification, only the plate-shaped portion 50B is disposed in the storage cavity 30 of the liquid injection hopper 3, and the plate-shaped portion 50A is not disposed. Also in the present modification, the contact portion 51 is in contact with the side walls 43, 45, and 46 at the edge of the plate-shaped portion 50B, and the separation portion 52 has a gap with the side wall 42. However, in the present modification, since the plate-shaped portion 50A is not provided, a space between the separation portion 52 of the plate-shaped portion 50B and the peripheral wall 32 is preferably as small as possible within a range where the electrolyte solution can pass.

Even when only one of the plate-shaped portion 50A or 50B is provided, the same actions and effects as those of the above-described embodiment and the like are achieved. That is, even when the small droplets D occur by the bursting of the bubbles V as described above, the small droplets D are effectively prevented from moving to the side where the lid member 26 (opening 33) is positioned beyond the plate-shaped portion (50A or 50B). Accordingly, the small droplets D of the electrolyte solution occurring by the bursting of the bubbles V discharged from the battery 7 are appropriately prevented from leaking to the outside of the liquid injection hopper 3.

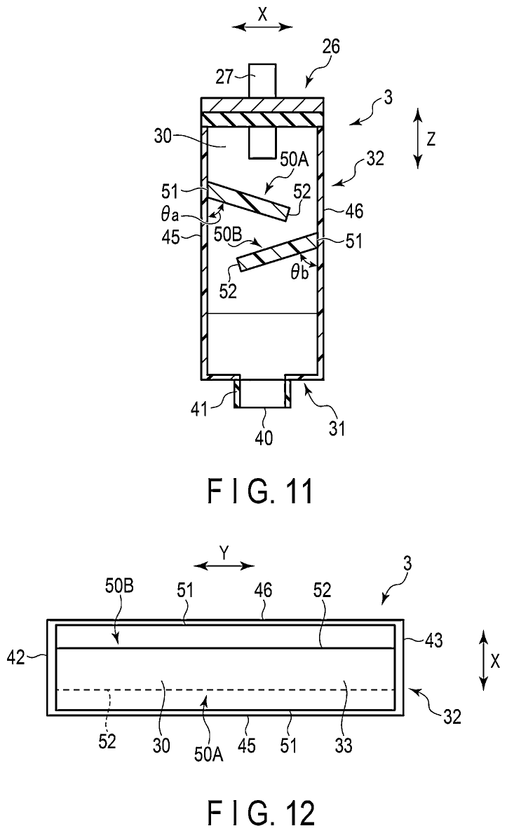

In addition, also in a fourth modification shown in FIGS. 11 and 12, the plate-shaped portions 50A and 50B are disposed in the storage cavity 30, and a contact portion 51 in contact with the peripheral wall 32 and a separation portion 52 having a gap with the peripheral wall 32 are formed at the edge of each of the plate-shaped portions 50A and 50B. However, in the present modification, in the plate-shaped portion (first plate-shaped portion) 50A, the contact portion 51 is in contact with the side wall (first side wall) 45, and the separation portion 52 forms a gap with the side wall (second side wall) 46. Then, in the plate-shaped portion (second plate-shaped portion) 50B, the contact portion 51 is in contact with the side wall (second side wall) 46, and the separation portion 52 forms a gap with the side wall (first side wall) 45. In addition, in each of the plate-shaped portions 50A and 50B, the contact portion 51 is in contact with each of the side wall (third side wall) 42 and the side wall (fourth side wall) 43.

Due to the above-described configuration, in the present modification, the peripheral wall 32 comes into contact with the edge of the plate-shaped portion 50A from both sides in the width direction and one side in the depth direction. Then, the peripheral wall 32 comes into contact with the plate-shaped portion 50B from both sides in the width direction and from the side opposite to the side in contact with the plate-shaped portion 50A in the depth direction. In addition, a gap between the separation portion 52 of the plate-shaped portion 50A and the side wall 46 of the peripheral wall 32 is positioned away from the contact portion 51 of the plate-shaped portion 50A in the circumferential direction of the storage cavity 30. Then, a gap between the separation portion 52 of the plate-shaped portion 50B and the side wall 45 of the peripheral wall 32 is positioned away from the contact portion 51 of the plate-shaped portion 50B in the circumferential direction of the storage cavity 30. It should be noted that FIG. 11 shows the liquid injection hopper 3 and the like in a cross-section orthogonal or substantially orthogonal to the width direction, and FIG. 11 shows the lid member 26 and the nozzle 27 in addition to the liquid injection hopper 3. In addition, FIG. 12 shows the liquid injection hopper 3 as viewed from one side in the height direction.

Also in the present modification, actions and effects similar to those of the above-described embodiment and the like are achieved. That is, even when the small droplets D occur by the bursting of the bubbles V as described above, the small droplets D are effectively prevented from moving to the side where the lid member 26 (opening 33) is positioned beyond the plate-shaped portion (50A or 50B). Accordingly, the small droplets D of the electrolyte solution occurring by the bursting of the bubbles V discharged from the battery 7 are appropriately prevented from leaking to the outside of the liquid injection hopper 3.

In addition, also in the present modification, each of the plate-shaped portions 50A and 50B is inclined to be in a state of being positioned on the side where the bottom wall 31 (discharge port 40) is positioned in the height direction as it comes closer to the separation portion 52. That is, each of the above-described angles θa and θb becomes an acute angle. Therefore, similarly to the above-described embodiment and the like, the electrolyte solution L discharged from the nozzle 27 is less likely to stay on the surface facing the side where the opening 33 (lid member 26) is positioned in each of the plate-shaped portions 50A and 50B. Therefore, even when the bubbles V burst in the storage cavity 30, the small droplets D caused by the electrolyte solution that stays in the plate-shaped portions 50A and 50B do not occur or hardly occur.

In addition, similarly to the fourth modification shown in FIGS. 11 and 12, in the configuration in which the plate-shaped portion 50A forming the gap with the side wall 46 and the plate-shaped portion 50B forming the gap with the side wall 45 are provided, each of the acute angles θa and θb may be made smaller than those of the modification in FIGS. 11 and 12, similarly to the first modification shown in FIG. 8. In addition, similarly to the fourth modification shown in FIGS. 11 and 12, in the configuration in which the plate-shaped portion 50A forming the gap with the side wall 46 and the plate-shaped portion 50B forming the gap with the side wall 45 are provided, the angle formed by each of the plate-shaped portions 50A and 50B with respect to the height direction of the liquid injection hopper 3 may be changeable, similarly to the second modification shown in FIG. 9. In this case, each of the above-described angles θa and θb can be changed. Then, the plate-shaped portion 50A is pivotable around a connection position to the side wall 45, and the plate-shaped portion 50B is pivotable around a connection position to the side wall 46. In addition, the pivoting axis of each of the plate-shaped portions 50A and 50B extends along the width direction of the liquid injection hopper 3.

In addition, in a certain modification, in the storage cavity 30 of the liquid injection hopper 3, only the plate-shaped portion 50A in which the separation portion 52 forms a gap with the side wall 46 is disposed, and the plate-shaped portion 50B is not disposed. Also in this case, similarly to the fourth modification shown in FIGS. 11 and 12, at the edge of the plate-shaped portion 50A, a contact portion 51 comes into contact with the side walls 42, 43, and 45, and a separation portion 52 has a gap with the side wall 46. However, in the present modification, since the plate-shaped portion 50B is not provided, a space between the separation portion 52 of the plate-shaped portion 50A and the peripheral wall 32 is preferably as small as possible within a range where the electrolyte solution can pass.

In addition, in a certain modification, in the storage cavity 30 of the liquid injection hopper 3, only the plate-shaped portion 50B in which the separation portion 52 forms a gap with the side wall 45 is disposed, and the plate-shaped portion 50A is not disposed. Also in this case, similarly to the fourth modification shown in FIGS. 11 and 12, at the edge of the plate-shaped portion 50B, a contact portion 51 comes into contact with the side walls 42, 43, and 46, and a separation portion 52 has a gap with the side wall 45. However, in the present modification, since the plate-shaped portion 50A is not provided, a space between the separation portion 52 of the plate-shaped portion 50B and the peripheral wall 32 is preferably as small as possible within a range where the electrolyte solution can pass.

In addition, in the above-described embodiment and the like, the peripheral wall 32 of the liquid injection hopper 3 includes the side walls 42, 43, 45, and 46 and is formed in a rectangular tubular shape or a substantially rectangular tubular shape, but it is not limited thereto. For example, the peripheral wall 32 of the liquid injection hopper 3 may be formed in a cylindrical shape or a substantially cylindrical shape, or may be formed in a triangular tubular shape or a substantially triangular tubular shape.

That is, the peripheral wall 32 only needs to surround the storage cavity 30 from the outer peripheral side, and the bottom wall 31 only needs to be connected to one end of the peripheral wall 32 in a state of being adjacent to the storage cavity 30 from one side in the height direction of the liquid injection hopper 3. Then, in the storage cavity 30 of the liquid injection hopper 3 in which the bottom wall 31 and the peripheral wall 32 are formed as described above, one or more plate-shaped portions (for example, at least one of 50A or 50B) only need to be connected to the peripheral wall 32, and the contact portion 51 and the separation portion 52 only need to be formed at the edge of each of the one or more plate-shaped portions (for example, at least one of 50A or 50B). With such a configuration, similarly to the above-described embodiment and the like, the small droplets D of the electrolyte solution occurring by the bursting of the bubbles V discharged from the battery 7 are appropriately prevented from leaking to the outside of the liquid injection hopper 3.

According to at least one e of the embodiments or examples, in the storage cavity of the liquid injection jig, the plate-shaped portion is connected to the peripheral wall. A contact portion in contact with the peripheral wall and a separation portion having a gap with the peripheral wall are formed at the edge of the plate-shaped portion, and the gap between the separation portion of the plate-shaped portion and the peripheral wall is positioned away from the contact portion of the plate-shaped portion in the circumferential direction of the storage cavity. Accordingly, it is possible to provide a liquid injection jig that appropriately prevents leakage of small droplets of an electrolyte solution occurring by the bursting of the bubbles discharged from the battery to the outside, and a liquid injection system including the liquid injection jig.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid injection jig comprising:
a peripheral wall surrounding, from an outer peripheral side, a storage cavity allowed to store an electrolyte solution;
a bottom wall connected to one end of the peripheral wall in a state of being adjacent to the storage cavity from one side in a height direction, the bottom wall having a discharge port formed therein, through which the electrolyte solution to be injected into a battery is allowed to be discharged from the storage cavity toward an inside of the battery; and
a plate-shaped portion connected to the peripheral wall in the storage cavity, the plate-shaped portion including, at an edge, a contact portion in contact with the peripheral wall and a separation portion having a gap with the peripheral wall, the gap between the separation portion and the peripheral wall being positioned away from the contact portion in a circumferential direction of the storage cavity.

2. The liquid injection jig according to claim 1, wherein the plate-shaped portion is inclined with respect to the height direction in a state of being positioned on a side where the bottom wall is positioned in the height direction as it comes closer to the separation portion.

3. The liquid injection jig according to claim 1, wherein an angle formed by the plate-shaped portion with respect to the height direction is changeable.

4. The liquid injection jig according to claim 1,
wherein the peripheral wall includes a first side wall and a second side wall facing the first side wall with the storage cavity interposed,
wherein the contact portion of the plate-shaped portion is in contact with the first side wall, and
wherein the separation portion of the plate-shaped portion forms the gap with the second side wall.

5. The liquid injection jig according to claim 4,
wherein the peripheral wall further includes a third side wall and a fourth side wall each of which connects the first side wall and the second side wall,
wherein the fourth side wall faces the third side wall with the storage cavity interposed, and
wherein the contact portion of the plate-shaped portion is in contact with each of the third side wall and the fourth side wall.

6. The liquid injection jig according to claim 1,
wherein the plate-shaped portion includes a first plate-shaped portion and a second plate-shaped portion each having edge at which the contact portion and the separation portion are formed, and
wherein the second plate-shaped portion forms a gap with the first plate-shaped portion in the storage cavity.

7. The liquid injection jig according to claim 6,
wherein the peripheral wall includes a first side wall and a second side wall facing the first side wall with the storage cavity interposed,
wherein in the first plate-shaped portion, the contact portion is in contact with the first side wall, and the separation portion forms the gap with the second side wall, and
wherein in the second plate-shaped portion, the contact portion is in contact with the second side wall, and the separation portion forms the gap with the first side wall.

8. A liquid injection system comprising:
the liquid injection jig according to claim 1; and
the battery including an exterior portion and an electrode group stored inside the exterior portion, the exterior portion having a liquid injection port formed in the exterior portion for injecting the electrolyte solution discharged from a discharge port of the liquid injection jig into the inside of the exterior portion.

9. The liquid injection system according to claim 8, further comprising:
a lid member attached to the peripheral wall of the liquid injection jig from a side opposite to a side on which the bottom wall is positioned in the height direction, the lid member covering an opening of the storage cavity opened to the side opposite to the side on which the bottom wall is positioned, and
a nozzle attached to the lid member, the nozzle discharging the supplied electrolyte solution toward the storage cavity of the liquid injection jig.

10. The liquid injection system according to claim 8, further comprising:
a chamber in which the battery is disposed in injection of the electrolyte solution from the liquid injection jig into the battery, and
a pressure adjustment unit configured to reduce pressure in the inside of the chamber in the injection of the electrolyte solution from the liquid injection jig into the battery.
